(19) United States
(12) Patent Application Publication
(10) Pub. No.: US 2026/0024892 A1
(43) Pub. Date: Jan. 22, 2026

(54) HIGH VOLTAGE HEADER WATER RESISTANT PROTECTION WITH CAPTURED BUSBAR

(71) Applicant: GM Global Technology Operations LLC, Detroit, MI (US)

(72) Inventors: Timothy Glenn Ross, Washington, MI (US); William John Bartlomiej, II, New Haven, MI (US); Jason Mazza, Bayonne, NJ (US); Hunter Clasen, Interlochen, MI (US); William Maas, Detroit, MI (US); Sean Puchalski, Warren, MI (US); Timothy Vander Woude, Royal Oak, MI (US); Benjamin Mulder, Madison Heights, MI (US)

(21) Appl. No.: 18/775,841

(22) Filed: Jul. 17, 2024

(51) Int. Cl. H01M 50/545; B60L 53/16; H01M 50/186; H01M 50/296; H01M 50/553

(52) U.S. Cl. CPC H01M 50/545; H01M 50/186; H01M 50/296; H01M 50/553; B60L 53/16

(57) ABSTRACT

A vehicle water resistant protection assembly includes a vehicle battery pack having an outer wall and an inner compartment. A rechargeable energy storage system (RESS) connector assembly includes a housing mounted within the inner compartment to an outer wall interior facing surface. An external adapter mounted to an outer wall exterior facing surface is in communication with the RESS connector assembly through the outer wall. A first cylindrical busbar and a second cylindrical busbar are disposed within the housing. A first snorkel and a second snorkel defining integral extensions of the housing have the first cylindrical busbar extending through and outward from the housing via the first snorkel and the second cylindrical busbar extending through and outward from the housing via the second snorkel. At least one O-ring is positioned on the second cylindrical busbar to mitigate against a fluid intruding into an inner cavity of the housing.

### INTRODUCTION

The present disclosure relates to rechargeable energy storage system (RESS) connectors.

For vehicle use, a rechargeable energy storage system (RESS) defines a system that provides energy including battery power, other than from fuel for propulsion as its primary use. RESS connectors are employed for high voltage (HV) headers, which commonly range from approximately 50 to 200 volts direct current (VDC) for hybrid vehicles and range from approximately 400 to 800 VDC for electric-only vehicles. Backing plates are commonly used within the RESS connectors which are not sealed against an internal environment of the RESS but have face seals at locations of HV header mounting bolts to mitigate against an external liquid entering the HV headers or the vehicle battery past the HV header mounting bolts.

Thus, while current systems and methods to provide resistance to water entry into RESS systems achieve their intended purpose, there is a need for a new and improved system and method to mitigate against moisture intrusion into a rechargeable energy storage system (RESS) connector assembly.

### SUMMARY

According to several aspects, a rechargeable energy storage system (RESS) connector assembly comprises a housing of a non-conductive material. A first cylindrical busbar and a second cylindrical busbar are disposed within the housing. A first snorkel and a second snorkel defining integral extensions of the housing have the first cylindrical busbar extending individually through and outward from the housing via the first snorkel and the second cylindrical busbar extending individually through and outward from the housing via the second snorkel. A first high voltage fitting and a second high voltage fitting are fixed to and extend individually from the first cylindrical busbar and the second cylindrical busbar, wherein high voltage defines a direct current (DC) voltage of at least 50 volts direct current (VDC).

In another aspect of the present disclosure, the first cylindrical busbar and the second cylindrical busbar provide main conductive paths to high voltage headers, including a battery electric vehicle (BEV) battery pack.

In another aspect of the present disclosure, a first third-hand feature and a second third-hand feature are connected to the housing and independently fixed to a housing wall of the battery pack to releasably retain the RESS connector assembly to the battery pack.

In another aspect of the present disclosure, a leading portion of the first third-hand feature is slidably inserted into a first receiving aperture created in an end wall of the battery pack until a first biasing member defining the leading portion of the first third-hand feature elastically displaces in a first outward direction to capture the first biasing member against an outer facing surface of the end wall. An extending portion of the second third-hand feature is slidably inserted into a second receiving aperture created in the end wall of the battery pack until a second biasing member defining the extending portion of the second third-hand feature elastically displaces in a second outward direction to capture the second biasing member against the outer facing surface.

In another aspect of the present disclosure, multiple threaded inserts include a first threaded insert, a second threaded insert, a third threaded insert and a fourth threaded insert are positioned on a perimeter of the housing. The multiple threaded inserts permit the housing to be releasably mounted using threaded fasteners to a housing wall of a vehicle battery pack.

In another aspect of the present disclosure, a press-in-place (PIP) seal is located proximate to perimeter wall of the housing mitigating against fluid intrusion into an inner cavity of the housing when the housing is pressed into contact with a housing wall of the vehicle battery pack. Multiple face seals, including a first face seal, a second face seal, a third face seal and a fourth face seal create a fluid boundary seal about a perimeter of individual ones of the first threaded insert, the second threaded insert, the third threaded insert and the fourth threaded insert when the housing is pressed into contact with the housing wall.

In another aspect of the present disclosure, a first bolt extending through the first cylindrical busbar creates a clamp load between mating busbars including a first high voltage fitting and releasably fixed using a first fastening nut to a first adapter busbar of an external adapter engaged to the RESS connector assembly. A second bolt extending through the second cylindrical busbar creates a clamp load between a second high voltage fitting and releasably fixed using a second fastening nut to a second adapter busbar of the external adapter.

In another aspect of the present disclosure, a first O-ring is located on an outer wall of the second cylindrical busbar and a second O-ring is located on the outer wall of the second cylindrical busbar, the first O-ring and the second O-ring mitigate against fluid intrusion into an inner cavity of the housing, the second O-ring positioned above the first O-ring and defining a maximum height protection against fluid intrusion into the inner cavity of the housing.

In another aspect of the present disclosure, the first snorkel and the second snorkel define high voltage insulation for the first cylindrical busbar and the second cylindrical busbar and provide additional insulated extension of the first cylindrical busbar and the second cylindrical busbar without exposure of a conductive material of the first cylindrical busbar or the second cylindrical busbar.

In another aspect of the present disclosure, the housing is molded defining a polymeric material including polyhexamethyleneadipamide. The first cylindrical busbar and the second cylindrical busbar define a T-shape and define a conductive material.

According to several aspects, a vehicle water resistant protection assembly comprises a battery pack of a vehicle having an outer wall and an inner compartment. A rechargeable energy storage system (RESS) connector assembly has a housing mounted within the inner compartment to an interior facing surface of the outer wall. An external adapter is mounted to an exterior facing surface of outer wall and is in communication with the RESS connector assembly through the outer wall. A first cylindrical busbar and a second cylindrical busbar are disposed predominantly within the housing. A first snorkel and a second snorkel defining integral extensions of the housing have the first cylindrical busbar extending individually through and outward from the housing via the first snorkel and the second cylindrical busbar extending individually through and outward from the housing via the second snorkel. At least one O-ring positioned on an outer wall of the second cylindrical busbar mitigates against a fluid intruding into an inner cavity of the housing.

In another aspect of the present disclosure, a press-in-place (PIP) seal located proximate to a perimeter wall of the housing mitigating fluid intrusion into the inner cavity of the housing when the housing is pressed into contact with the interior facing surface of the outer wall of the battery pack.

In another aspect of the present disclosure, the at least one O-ring includes a first O-ring located on an outer wall of the second cylindrical busbar and a second O-ring located on the outer wall of the second cylindrical busbar, the second O-ring positioned above the first O-ring and providing a maximum height protection against the fluid intruding into the inner cavity of the housing.

In another aspect of the present disclosure, a first bolt extending through the first cylindrical busbar creates a clamp load between mating busbars including a first high voltage fitting and releasably fixed using a first fastening nut to a first adapter busbar of an external adapter engaged to the RESS connector assembly. A second bolt extending through the second cylindrical busbar creates a clamp load between a second high voltage fitting and releasably fixed using a second fastening nut to a second adapter busbar of the external adapter. High voltage defines a direct current (DC) voltage of at least 50 volts DC.

In another aspect of the present disclosure, multiple threaded inserts include a first threaded insert, a second threaded insert, a third threaded insert and a fourth threaded insert positioned on a perimeter of the housing, the multiple threaded inserts permitting the housing to be releasably mounted using threaded fasteners to the interior facing surface of the outer wall of the battery pack. Multiple face seals, including a first face seal, a second face seal, a third face seal and a fourth face seal create a fluid boundary seal at individual ones of the first threaded insert, the second threaded insert, the third threaded insert and the fourth threaded insert when the housing abuts the outer wall.

In another aspect of the present disclosure, a first third-hand feature and a second third-hand feature are connected to the housing and are independently fixed to the outer wall of the battery pack to releasably retain the RESS connector assembly to the battery pack. A portion of the first third-hand feature is slidably inserted into a first receiving aperture created in the outer wall of the battery pack. A portion of the second third-hand feature is slidably inserted into a second receiving aperture created in the outer wall of the battery pack.

In another aspect of the present disclosure, a first high voltage fitting and a second high voltage fitting are fixed to and extend individually from the first cylindrical busbar and the second cylindrical busbar. High voltage defines a direct current (DC) voltage at or above approximately 50 volts direct current (VDC).

According to several aspects, a method for providing vehicle battery water resistant protection comprises: positioning a battery pack within a vehicle, the battery pack having an outer wall and an inner compartment; creating a rechargeable energy storage system (RESS) connector assembly having a housing mounted within the inner compartment to an interior facing surface of the outer wall; mounting an external adapter to an exterior facing surface of the outer wall and in communication with the RESS connector assembly through the outer wall; disposing a first cylindrical busbar and a second cylindrical busbar predominantly within the housing; providing integral extensions of the housing including a first snorkel and a second snorkel; extending the first cylindrical busbar individually through and outward from the housing via the first snorkel and extending the second cylindrical busbar individually through and outward from the housing via the second snorkel; and positioning at least one O-ring on an outer wall of the second cylindrical busbar acting to mitigate against fluid intrusion into an inner cavity of the housing.

In another aspect of the present disclosure, the method further includes: providing a press-in-place (PIP) seal proximate to a perimeter wall of the housing to mitigate against fluid intrusion into the inner cavity of the housing when the housing is pressed into contact with the interior facing surface of the outer wall of the battery pack; positioning multiple threaded inserts at the perimeter wall of the housing to permit the housing to be releasably mounted using threaded fasteners to the interior facing surface of the outer wall of the battery pack; and locating multiple face seals which create a fluid boundary seal at the multiple threaded inserts when the housing is pressed into contact with the housing wall.

In another aspect of the present disclosure, the method further includes: connecting a first third-hand feature and a second third-hand feature to the housing and independently fixed to the outer wall of the battery pack to releasably retain the RESS connector assembly to the battery pack; slidably inserting a portion of the first third-hand feature into a first receiving aperture created in the outer wall of the battery pack; and slidably extending a portion of the second third-hand feature into a second receiving aperture created in the outer wall of the battery pack.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a front elevational view of a RESS connector assembly according to an exemplary aspect;

FIG. 2 is a cross sectional side elevational view of the RESS connector of FIG. 1 combined with an external adapter of a high voltage connector assembly;

FIG. 3 is a top perspective view of RESS connector assembly of FIG. 1;

FIG. 4 is a top left perspective view of a vehicle having a battery pack adapted for use of the RESS connector assembly of FIG. 1;

FIG. 5 is a top perspective view of a battery pack adapted for use of the RESS connector assembly of FIG. 1;

FIG. 6 is a cross sectional end elevational view taken as section 6 of FIG. 5;

FIG. 7 is an end elevational view of a wall portion of the battery pack of FIG. 5;

FIG. 8 is a cross sectional side elevational view modified from FIG. 3 further showing a maximum fluid level;

FIG. 9 is a perspective assembly view of the components of the components of FIG. 2; and

FIG. 10 is a perspective assembly view of a further aspect of a RESS connector assembly and high voltage connector assembly similar to FIG. 8.

### DETAILED DESCRIPTION

The following description is merely exemplary in nature and is not intended to limit the present disclosure, application, or uses.

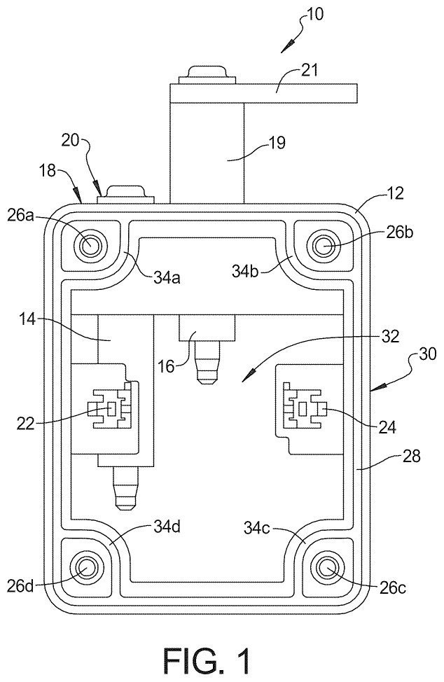

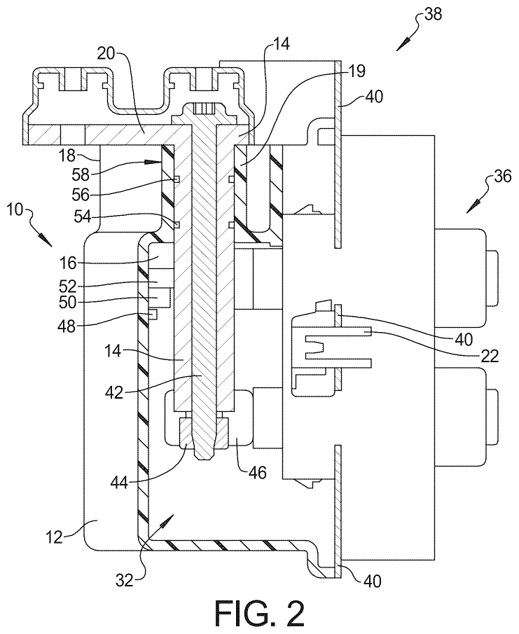

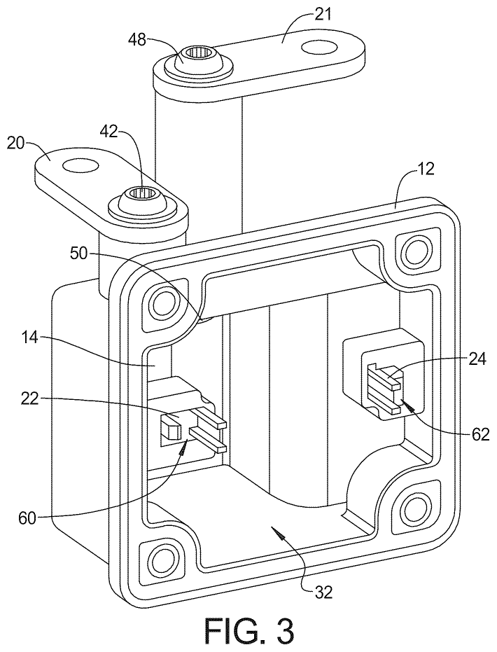

Referring to FIG. 1, a rechargeable energy storage system (RESS) connector assembly 10 includes a housing 12 which may be molded from a nonconductive polymeric material such as polyhexamethyleneadipamide (nylon). A first cylindrical busbar 14 and a second cylindrical busbar 16, which according to several aspects may be formed of a conductive material such as copper, are disposed within and extend partially out of the housing 12. The first cylindrical busbar 14 and the second cylindrical busbar 16 provide main conductive paths to high voltage headers, for example of a battery electric vehicle battery pack shown and described in greater detail in reference to FIG. 5. The first cylindrical busbar 14 and the second cylindrical busbar 16 have a T-shape and extend through and outward from the housing 12 via a first snorkel 18, shown and described in greater detail in reference to FIGS. 2 and 3, and a second snorkel 19, which define integral extensions of the molded housing 12. The first snorkel 18 and the second snorkel 19 provide high voltage insulation for the first cylindrical busbar 14 and the second cylindrical busbar 16. A further function of the first snorkel 18 and the second snorkel 19 are to provide additional insulated extension of the first cylindrical busbar 14 and the second cylindrical busbar 16 without exposure of the conductive material of the first cylindrical busbar 14 or the second cylindrical busbar 16.

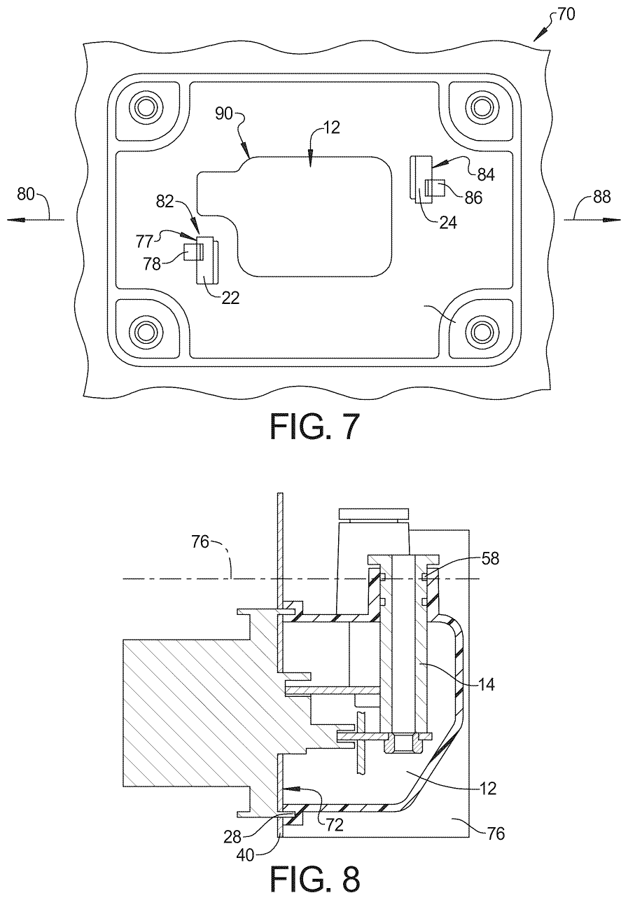

The RESS connector assembly 10 also includes a first high voltage fitting 20, shown and described in greater detail in reference to FIG. 3, and a second high voltage fitting 21 which are fixed to and extend individually from the first cylindrical busbar 14 and the second cylindrical busbar 16. A first third-hand feature 22 and a second third-hand feature 24, which may be of a polymeric material or a metal material, are independently fixed to the housing 12, whose functions are described in greater detail in reference to FIG. 7. Multiple threaded inserts, including a first threaded insert 26a, a second threaded insert 26b, a third threaded insert 26c and a fourth threaded insert 26d are positioned on a perimeter of the housing 12, which permit the housing 12 to be releasably mounted for example using threaded fasteners to a battery pack structure shown and described in reference to FIGS. 5 and 9 through 11. A press-in-place (PIP) seal 28 is located proximate to and extends entirely about a perimeter wall 30 of the housing 12 to mitigate against fluid intrusion into an inner cavity 32 of the housing 12. The PIP seal 28 is enhanced by the further addition of multiple face seals, including a first face seal 34a, a second face seal 34b, a third face seal 34c and a fourth face seal 34d which provide a fluid boundary seal about a perimeter of individual ones of the first threaded insert 26a, the second threaded insert 26b, the third threaded insert 26c and the fourth threaded insert 26d.

Referring to FIG. 2 and again to FIG. 1, the RESS connector assembly 10 may be releasably connected to an external adapter 36 located for example exterior to a vehicle battery pack to form a high voltage connector assembly 38. An exterior wall 40, for example of a metal material, separates a vehicle battery pack interior space from an external environment. The first third- hand feature 22 and the second third-hand feature 24 are provided to temporarily mount the RESS connector assembly 10 to the exterior wall 40, prior to installation of the external adapter 36.

A first bolt 42 extends through the first cylindrical busbar 14 to provide a clamp load between mating busbars including the first high voltage fitting 20 and is releasably fixed using a first fastening nut 44 to a first adapter busbar 46 of the external adapter 36. A second bolt 48 extends through the second cylindrical busbar 16 to provide a clamp load between mating busbars including the second high voltage fitting 21 shown in FIG. 1 and is releasably fixed using a second fastening nut 50 to a second adapter busbar 52 of the external adapter 36.

To mitigate against fluid intrusion into the inner cavity 32 of the housing 12 the first cylindrical busbar 14 and the second cylindrical busbar 16 include O-ring seals located on an outer wall of the busbars. For example, the first cylindrical busbar 14 includes a first O-ring 54 and a second O-ring 56 located within predisposed O-ring grooves created in an outer wall 58 of the first cylindrical busbar 14. A fluid present within a battery pack due for example to a leaking coolant source may accumulate to a level at least partially submerging the RESS connector assembly 10. The second O-ring 56 is positioned above the first O-ring 54 and defines a maximum height protection against fluid intrusion into the inner cavity 32 of the housing 12.

Referring to FIG. 3 and again to FIGS. 1 and 2, the first third-hand feature 22 and the second third-hand feature 24 define biasing members which are provided to initially retain the RESS connector assembly 10 during installation of the RESS connector assembly 10 pending installation of the external adapter 36 described in reference to FIG. 2. The first third-hand feature 22 and the second third-hand feature 24 in use are retained within receiving apertures molded into the housing 12 shown and described in reference to FIG. 7.

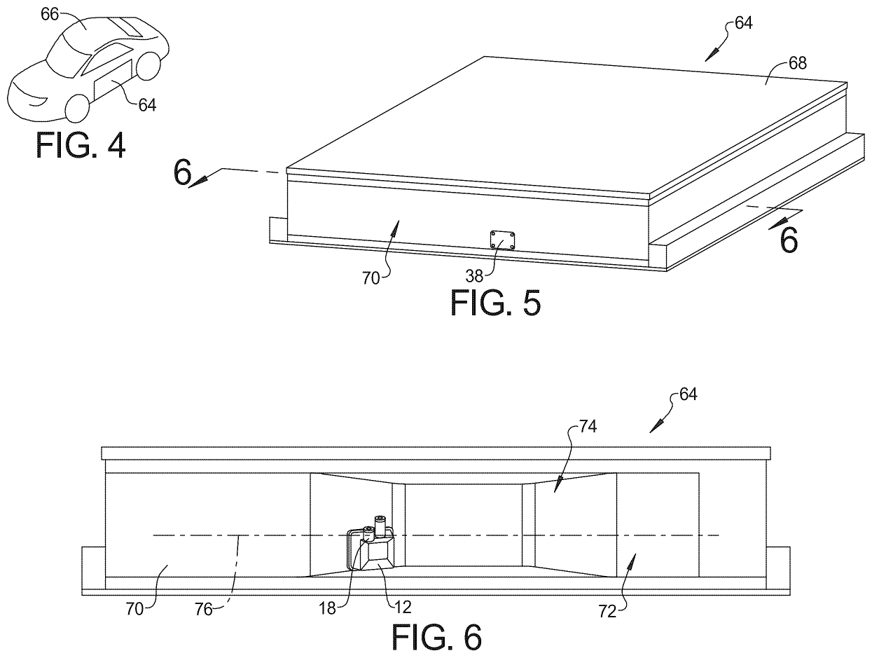

Referring to FIG. 4 and again to FIGS. 1 and 2, a battery pack having the RESS connector assembly 10 is installed in a vehicle 66. According to several aspects, the vehicle 66 may be a battery electric vehicle (BEV) or a hybrid electric vehicle. The vehicle 66 may be any vehicle type including a sedan, a sport utility vehicle, a van, a truck or the like.

Referring to FIG. 5 and again to FIGS. 1 through 4, the battery pack 64 includes a housing 68 having at least one end wall 70. The external adapter 36 of the high voltage connector assembly 38 shown and described in reference to FIG. 2 is releasably fixed to the end wall 70.

Referring to FIG. 6 and again to FIGS. 1 through 5, the housing 12 of the RESS connector assembly 10 shown and described in reference to FIGS. 1 through 3 is releasably fixed to an interior surface 72 of the end wall 70 of the battery pack 64. The PIP seal 28 shown and described in reference to FIG. 1 is positioned against the interior surface 72 to form a fluid resistant seal between the inner cavity 32 of the housing 12 and the interior surface 72. An interior space 74 of the battery pack 64 may collect a volume of fluid such as coolant if a coolant leak occurs within the interior space 74. The second O-ring 56 of the first cylindrical busbar 14 shown and described in reference to FIG. 2 mitigates against fluid intrusion past the cylindrical busbars into the inner cavity 32 of the housing 12 up to a maximum fluid level 76.

Referring to FIG. 7 and again to FIGS. 3, 5 and 6, during installation of the RESS connector assembly 10 a leading portion of the first third-hand feature 22 is slidably inserted into a first receiving aperture 77 created in the end wall 70 until a first biasing member 78 defining the leading portion of the first third-hand feature 22 elastically snaps in a first outward direction 80 to capture the first biasing member 78 against an outer facing surface 82 of the end wall 70. At the same time an extending portion of the second third-hand feature 24 is slidably inserted into a second receiving aperture 84 created in the end wall 70 until a second biasing member 86 defining the extending portion of the second third-hand feature 24 elastically snaps in a second outward direction 88 to capture the second biasing member 86 against the outer facing surface 82. The first biasing member 78 and the second biasing member 86 thereby releasably retain the housing in position against the interior surface 72 of the end wall 70 shown and described in reference to FIG. 6 until the external adapter 36 of the high voltage connector assembly 38 shown and described in reference to FIG. 2 is releasably fixed to the end wall 70 and to the housing 12. An opening 90 created through the end wall 70 at the mounting position of the RESS connector assembly 10 provides open communication between the inner cavity 32 of the housing 12 of the RESS connector assembly and the electrical connecting features of the external adapter 36.

Referring to FIG. 8 and again to FIGS. 1 and 2, the external adapter 36 of the high voltage connector assembly 38 shown and described in reference to FIG. 2 is releasably fixed to the end wall 70 and to the housing 12. The housing 12 is shown abutting the interior surface 72 of the end wall 70. As previously noted above with respect to FIG. 6 the second O-ring 56 of the first cylindrical busbar 14 shown and described in reference to FIG. 2 mitigates against fluid intrusion past the cylindrical busbars into the inner cavity 32 of the housing 12 up to the maximum fluid level 76.

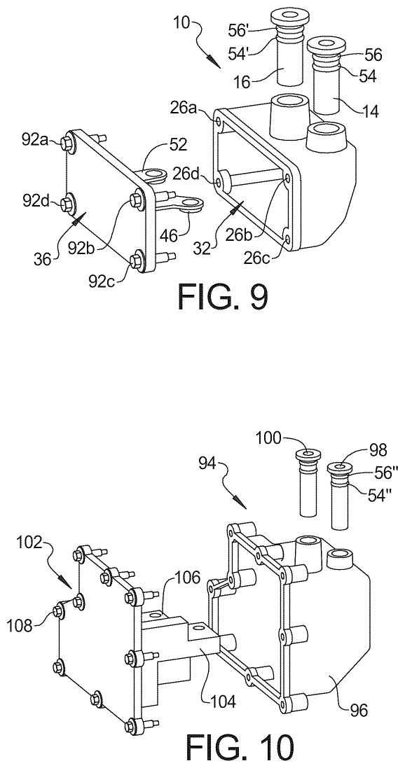

Referring to FIG. 9 and again to FIGS. 1, 2 and 8, to further mitigate against fluid intrusion into the inner cavity 32 of the housing 12, in addition to the first O-ring 54 and the second O-ring 56 provided with the first cylindrical busbar 14, the second cylindrical busbar 16 has similar O-rings, including a first O-ring 54′ and a second O-ring 56′. The external adapter 36 of the high voltage connector assembly 38 may be coupled to the housing 12 using multiple threaded fasteners, including a first threaded fastener 92a threadedly engaged with the first threaded insert 26a, and further threaded fasteners 92b, 92c and 92d threadedly engaged with the second threaded insert 26b, the third threaded insert 26c and the fourth threaded insert 26d.

Referring to FIG. 10 and again to FIGS. 1 and 2, according to several aspects, a RESS connector assembly 94 is modified from the RESS connector assembly 10 to include a housing 96 larger than the housing 12 and having a first cylindrical busbar 98 and a second cylindrical busbar 100 modified in length from the first cylindrical busbar 14 and the second cylindrical busbar 16 and further including a first O-ring 54″ and a second O-ring 56″. A high voltage connector assembly 102 is modified from the high voltage connector assembly 38 to include a first adapter busbar 104 larger than the first adapter busbar 46 and a second adapter busbar 106 larger than the second adapter busbar 52. The high voltage connector assembly 102 may be coupled to the housing 96 using multiple threaded fasteners, including a first threaded fastener 108.

The RESS connector assembly 10 and the RESS connector assembly 94 act as a backing plate for high voltage RESS connectors or headers and provide a sealed geometry of the backing plate. The sealed geometry protects a high voltage header against liquid in the instance of liquid intrusion into the RESS connector assembly. Electrical conductors within the sealed assembly are also protected against liquid intrusion. A snorkel device is used to form continuity with the high voltage electrical circuit, raising conductors above a projected high fluid level in a battery pack to protect them against liquid intrusion. Furthermore, standard face seals are replaced with a PIP seal, which has two functions. A first PIP seal function is to protect against liquid intrusion through an HV header bolt path. A second PIP seal function is to protect against liquid intrusion from a battery pack internal environment.

To aid in assembly, the snorkel contains a captured cylindrical busbar. The cylindrical busbar is embedded within the snorkel, providing a low resistance connection path between the protected high voltage header and the RESS-internal bussing. By capturing the busbar, assembly operations at a battery assembly plant are streamlined, with fewer loose parts to assemble. O-rings are used on the busbars in the snorkel assembly to interface with the captured busbar. The O-rings serve a dual purpose. A first O-ring purpose is to capture the busbar during RESS connector assembly. A second O-ring purpose is to protect against liquid ingress through the snorkel assembly which may be due to fluid presence such as from a cooling system leak in an internal volume of a battery pack.

Using a combination of a T-shaped busbar geometry and the O-Rings, the captured busbar is effectively held in place before assembly. Furthermore, the O-rings mitigate against liquid intrusion into the sealed backing plate through the snorkel. Traditional RESS operations may further create condensation, which may eventually collect within the sealed snorkel assembly which could cause an electrical hazard. By use of the O-rings, liquid ingress through the snorkels by means of condensation or splashing is significantly reduced.

The RESS connector assembly 10 of the present disclosure together with the external adapter 36 forming the high voltage connector assembly 38 define a vehicle water resistant protection assembly, with the RESS connector assembly 10 substituting for an HV header backing plate in a sealed assembly. The sealed backing plate protects against both liquid intrusion through RESS-external bolts and RESS-internal water ingress. A sealed backing plate with third hand features of the present RESS connectors provides easy assembly. A sealed backing plate with cylindrical busbars and outwardly extending housing snorkels keep high voltage conductors isolated from RESS-internal fluid faults. A sealed backing plate with snorkels and captured busbars improves assembly at a battery assembly plant. The sealed backing plate with snorkel, cylindrical busbar, and O-rings further protects the sealed backing plate assembly against liquid intrusion from the snorkel, such as condensation or splashing. The sealed backing plate with snorkel, T-shaped cylindrical busbar, and O-rings are used in combination to capture the busbar and retain the busbar in position during transit. The sealed backing plate with snorkels allows O-ring compression during both transit and installed states, which allows the O-rings to double function as both capturing devices and sealing devices.

The RESS connector assemblies of the present disclosure offer several advantages. These include: protection of RESS high voltage headers against liquid exposure. A “snorkel” provides a sealed, waterproof volume where liquid cannot enter. The snorkel doubles in purpose as a backing plate for high voltage RESS connectors (headers). The design of the present disclosure also includes assembly-aiding features, including a 3rd hand clip feature. In addition, a combination of PIP and O-Ring seals ensures the system remains sealed against a variety of liquid ingress paths. The high voltage headers are protected against RESS liquid intrusion. High voltage headers may therefore be placed in any location, regardless of liquid intrusion risk. The captured busbar design streamlines the assembly of the snorkel. Protection is also provided of a high voltage header against condensation/splashing through the inclusion of the O-rings incorporated in the snorkel design.

What is claimed is:

1. A rechargeable energy storage system (RESS) connector assembly, comprising:
a housing of a non-conductive material;
a first cylindrical busbar and a second cylindrical busbar disposed within the housing;
a first snorkel and a second snorkel defining integral extensions of the housing, having the first cylindrical busbar extending individually through and outward from the housing via the first snorkel and the second cylindrical busbar extending individually through and outward from the housing via the second snorkel; and
a first high voltage fitting and a second high voltage fitting fixed to and extending individually from the first cylindrical busbar and the second cylindrical busbar, wherein high voltage defines a direct current (DC) voltage of at least approximately 50 volts direct current (VDC).

2. The RESS connector assembly of claim 1, wherein the first cylindrical busbar and the second cylindrical busbar provide main conductive paths to high voltage headers, including a vehicle battery pack.

3. The RESS connector assembly of claim 2, including a first third-hand feature and a second third-hand feature connected to the housing and independently fixed to a housing wall of the battery pack to releasably retain the RESS connector assembly to the battery pack.

4. The RESS connector assembly of claim 3, including:
a leading portion of the first third-hand feature slidably inserted into a first receiving aperture created in an end wall of the battery pack until a first biasing member of the first third-hand feature defining the leading portion elastically displaces in a first outward direction to capture the first biasing member against an outer facing surface of the end wall; and
an extending portion of the second third-hand feature slidably inserted into a second receiving aperture created in the end wall of the battery pack until a second biasing member defining the extending portion of the second third-hand feature elastically displaces in a second outward direction to capture the second biasing member against the outer facing surface.

5. The RESS connector assembly of claim 1, further including multiple threaded inserts, including a first threaded insert, a second threaded insert, a third threaded insert and a fourth threaded insert positioned on a perimeter of the housing, the multiple threaded inserts permitting the housing to be releasably mounted using threaded fasteners to a housing wall of a vehicle battery pack.

6. The RESS connector assembly of claim 5, including:
a press-in-place (PIP) seal located proximate to a perimeter wall of the housing mitigating against fluid intrusion into an inner cavity of the housing when the housing is pressed into contact with an outer wall of the vehicle battery pack; and
multiple face seals, including a first face seal, a second face seal, a third face seal and a fourth face seal which create a fluid boundary seal at individual ones of the first threaded insert, the second threaded insert, the third threaded insert and the fourth threaded insert when the housing is pressed into contact with the outer wall.

7. The RESS connector assembly of claim 1, further including:
a first bolt extending through the first cylindrical busbar creating a clamp load between mating busbars including a first high voltage fitting and releasably fixed using a first fastening nut to a first adapter busbar of an external adapter engaged to the RESS connector assembly; and
a second bolt extending through the second cylindrical busbar creating a clamp load between a second high voltage fitting and releasably fixed using a second fastening nut to a second adapter busbar of the external adapter.

8. The RESS connector assembly of claim 1, further including a first O-ring located on an outer wall of the second cylindrical busbar and a second O-ring located on the outer wall of the second cylindrical busbar, the first O-ring and the second O-ring mitigating a fluid intrusion into an inner cavity of the housing, the second O-ring positioned above the first O-ring and defining a maximum height protection against the fluid intrusion into the inner cavity of the housing.

9. The RESS connector assembly of claim 1, wherein the first snorkel and the second snorkel define high voltage insulation for the first cylindrical busbar and the second cylindrical busbar and provide additional insulated extension of the first cylindrical busbar and the second cylindrical busbar without exposure of a conductive material of the first cylindrical busbar or the second cylindrical busbar.

10. The RESS connector assembly of claim 1, wherein:
the housing is molded defining a nonconductive polymeric material including polyhexamethyleneadipamide; and
the first cylindrical busbar and the second cylindrical busbar define a T-shape and define a conductive material.

11. A vehicle water resistant protection assembly, comprising:
a battery pack of a vehicle having an outer wall and an inner compartment;
a rechargeable energy storage system (RESS) connector assembly having a housing mounted within the inner compartment to an interior facing surface of the outer wall;
an external adapter mounted to an exterior facing surface of outer wall and in communication with the RESS connector assembly through the outer wall;
a first cylindrical busbar and a second cylindrical busbar disposed predominantly within the housing;
a first snorkel and a second snorkel defining integral extensions of the housing, having the first cylindrical busbar extending individually through and outward from the housing via the first snorkel and the second cylindrical busbar extending individually through and outward from the housing via the second snorkel; and
at least one O-ring positioned on an outer wall of the second cylindrical busbar acting to mitigate against a fluid intruding into an inner cavity of the housing.

12. The vehicle water resistant protection assembly of claim 11, including a press-in-place (PIP) seal located proximate to a perimeter wall of the housing mitigating fluid intrusion into the inner cavity of the housing when the housing is pressed into contact with the interior facing surface of the outer wall of the battery pack.

13. The vehicle water resistant protection assembly of claim 11, wherein the at least one O-ring includes a first O-ring encircling an outer wall of the second cylindrical busbar and a second O-ring encircling the outer wall of the second cylindrical busbar, the second O-ring positioned above the first O-ring and providing a maximum height protection against the fluid intruding into the inner cavity of the housing.

14. The vehicle water resistant protection assembly of claim 11, including:
a first bolt extending through the first cylindrical busbar creating a clamp load between mating busbars including a first high voltage fitting and releasably fixed using a first fastening nut to a first adapter busbar of an external adapter engaged to the RESS connector assembly; and
a second bolt extending through the second cylindrical busbar creating a clamp load between a second high voltage fitting and releasably fixed using a second fastening nut to a second adapter busbar of the external adapter; and
wherein high voltage defines a direct current (DC) voltage of at least 50 volts DC.

15. The vehicle water resistant protection assembly of claim 11, Including:
multiple threaded inserts, including a first threaded insert, a second threaded insert, a third threaded insert and a fourth threaded insert positioned on a perimeter of the housing, the multiple threaded inserts permitting the housing to be releasably mounted using threaded fasteners to the interior facing surface of the outer wall of the battery pack; and
multiple face seals, including a first face seal, a second face seal, a third face seal and a fourth face seal which create a fluid boundary seal at individual ones of the first threaded insert, the second threaded insert, the third threaded insert and the fourth threaded insert when the housing abuts the outer wall.

16. The vehicle water resistant protection assembly of claim 11, including:
a first third-hand feature and a second third-hand feature connected to the housing and independently fixed to the outer wall of the battery pack to releasably retain the RESS connector assembly to the battery pack;
a portion of the first third-hand feature slidably inserted into a first receiving aperture created in the outer wall of the battery pack; and
a portion of the second third-hand feature slidably inserted into a second receiving aperture created in the outer wall of the battery pack.

17. The vehicle water resistant protection assembly of claim 11, including a first high voltage fitting and a second high voltage fitting fixed to and extending individually from the first cylindrical busbar and the second cylindrical busbar, wherein high voltage defines a direct current (DC) voltage at or above approximately 50 volts direct current (VDC).

18. A method for providing vehicle battery water resistant protection, comprising:
positioning a battery pack within a vehicle, the battery pack having an outer wall and an inner compartment;
creating a rechargeable energy storage system (RESS) connector assembly having a housing mounted within the inner compartment to an interior facing surface of the outer wall;
mounting an external adapter to an exterior facing surface of the outer wall and in communication with the RESS connector assembly through the outer wall;
disposing a first cylindrical busbar and a second cylindrical busbar predominantly within the housing;
providing integral extensions of the housing including a first snorkel and a second snorkel;
extending the first cylindrical busbar individually through and outward from the housing via the first snorkel and extending the second cylindrical busbar individually through and outward from the housing via the second snorkel; and
positioning at least one O-ring on an outer wall of the second cylindrical busbar mitigating against fluid intrusion into an inner cavity of the housing.

19. The method of claim 18, further including:
providing a press-in-place (PIP) seal proximate to a perimeter wall of the housing to mitigate against fluid intrusion into the inner cavity of the housing when the housing is pressed into contact with the interior facing surface of the outer wall of the battery pack;
positioning multiple threaded inserts at the perimeter wall of the housing to permit the housing to be releasably mounted using threaded fasteners to the interior facing surface of the outer wall of the battery pack; and
locating multiple face seals which create a fluid boundary seal at the multiple threaded inserts when the housing is pressed into contact with the outer wall.

20. The method of claim 18, further including:
connecting a first third-hand feature and a second third-hand feature to the housing and independently fixed to the outer wall of the battery pack to releasably retain the RESS connector assembly to the battery pack;
slidably inserting a portion of the first third-hand feature into a first receiving aperture created in the outer wall of the battery pack; and
slidably extending a portion of the second third-hand feature into a second receiving aperture created in the outer wall of the battery pack.
